(19) United States
(12) Patent Application Publication
(10) Pub. No.: US 2019/0376426 A1
(43) Pub. Date: Dec. 12, 2019

(54) CONTROL APPARATUS AND METHOD WITH NOX SENSOR CROSS SENSITIVITY FOR OPERATING AN INTERNAL COMBUSTION ENGINE

(71) Applicant: GM GLOBAL TECHNOLOGY OPERATIONS LLC, Detroit, MI (US)

(72) Inventors: Jaime Andres Cespedes Garcia, Torino (IT); Giuseppe Mazzara Bologna, Nicosia (IT); Maria Camuglia, Francavilla di Sicilia (IT); Carlos Idefonso Hoyos Velasco, Torino (IT); David Tulli, Torino (IT)

(73) Assignee: GM GLOBAL TECHNOLOGY OPERATIONS LLC, Detroit, MI (US)

(21) Appl. No.: 16/003,282

(22) Filed: Jun. 8, 2018

(51) Int. Cl. F01N 3/20; F01N 3/035; B01D 46/00; B01D 53/94

(52) U.S. Cl. CPC F01N 3/208; F01N 3/035; B01D 46/0027; B01D 53/9495; B01D 53/9418; B01D 2279/30; F01N 2610/02; F01N 2900/0408; F01N 2900/0416; F01N 2900/1411; F01N 2900/1402

(57) ABSTRACT

An after-treatment system includes a selective catalyst reduction on filter (SCRF) device in communication with exhaust gases from an engine yielding treated exhaust gases. A nitrogen oxides (NOx) sensor is configured to measure the treated exhaust gases and has an output signal that is NOx and ammonia (NH₃) cross-sensitive. A NOx sensor model is coupled to receive the output signal and mass flow data for the treated exhaust gases and provides a NOx model signal to an electronic control unit (ECU) that is operatively associated with the after-treatment system and the engine. The NOx model signal represents an exhaust gas NOx concentration estimate based upon an actual NOx concentration and an actual NH₃ concentration of the exhaust gas. The ECU is operable upon the NOx concentration estimate to control the after-treatment system and the engine to effect an overall reduction in actual NOx concentration of the treated exhaust gases.

### TECHNICAL FIELD

The technical field relates to a control apparatus for operating an internal combustion engine, and more particularly to a control apparatus for operating a diesel selective catalyst reduction on filter (SCRF) exhaust gas after-treatment system that incorporates an oxides of nitrogen (NOx) sensor model.

### BACKGROUND

An internal combustion engine for a motor vehicle generally includes an engine block defining at least one cylinder accommodating a reciprocating piston coupled to rotate a crankshaft. The cylinder is closed by a cylinder head that cooperates with the reciprocating piston to define a combustion chamber. A fuel and air mixture is cyclically disposed in the combustion chamber and ignited, thereby generating hot expanding exhaust gases that cause the reciprocating movements of the piston. The fuel is typically injected into each cylinder by a respective fuel injector. The fuel is provided at high pressure to each fuel injector from a fuel rail in fluid communication with a high pressure fuel pump that increases the pressure of the fuel received from a fuel source. Operation of the internal combustion engine is generally controlled by one or more electronic control units (ECUs) operably coupled to the internal combustion engine and an array of sensors and actuators, such as the fuel injector.

Due to stringent emissions regulation, internal combustion engines generally include exhaust gas after-treatment systems. An after-treatment system may include one or more after-treatment devices provided in an exhaust system of the internal combustion engine. For example, an after-treatment system may include an oxidation catalyst such as a diesel oxidation catalyst (DOC), which utilizes a chemical process in order to break down constituents from diesel engines in the exhaust stream, turning them into generally harmless compositions. DOCs typically have a honeycomb shaped configuration coated in a catalyst designed to trigger a chemical reaction to reduce these constituents. DOCs may contain palladium (Pd) and platinum (Pt) or cerium oxide, which serve as catalysts to oxidize hydrocarbons and carbon monoxide into carbon dioxide and water. An alternative to DOCs may be a three-way catalyst (TWC).

In a further alternative, a lean NOx trap (LNT) may be used. A LNT is a device that traps nitrogen oxides (NOₓ) contained in the exhaust gas and is generally located in the exhaust system upstream of a diesel particulate filter (DPF). More specifically, a LNT is a catalytic device containing catalysts, such as rhodium (Rh), Pt and Pd, and adsorbents, such as barium based elements, which provide active sites suitable for binding the nitrogen oxides (NOₓ) contained in the exhaust gas in order to trap them within the device itself.

After-treatment systems may also include a diesel particular filter (DPF) which filters the particulate matter (PM) and a selective catalytic reduction (SCR) device which is a catalytic device for reducing the nitrogen oxides (NOₓ) contained in the exhaust gas into diatomic nitrogen (N₂) and water (H₂O), with the aid of a gaseous reducing agent, typically ammonia (NH₃) that can be obtained by urea (CH₄N₂O) thermo-hydrolysis and that is absorbed inside the catalyst. Typically, urea is injected from a dedicated tank into the exhaust line where it mixes with the exhaust gas upstream the SCR. Other fluids can be used in a SCR in lieu of urea and are generally referred to as diesel exhaust fluids (DEF). An alternative to the SCR is a SCRF (SCR on Filter), namely a device that combines in a single unit an SCR device and a DPF.

Control of the after-treatment system, and in particular the control of the introduction of DEF to provide effective operation of the SCR/SCRF, requires an accurate indication of the NOx concentration of the exhaust gases. However, existing NOx sensors capable of being used in the exhaust gas flow of an ICE powered motor vehicle are cross-sensitive to NH₃, and therefore may not provide a reliable indication of NOx concentration. Providing an NH₃ sensor adds cost and complexity, and in any event, NH₃ sensors have insufficient accuracy.

### SUMMARY

In accordance with an embodiment, an exhaust gas after-treatment system is provided for an internal combustion engine that includes a selective catalyst reduction on filter (SCRF) exhaust gas after-treatment device in communication with exhaust gases from the internal combustion engine yielding a treated exhaust gas output. An oxides of nitrogen (NOx) sensor is in communication with the treated exhaust gases and has a NOx sensor output signal that is NOx and ammonia (NH₃) cross-sensitive. A NOx sensor model is operatively coupled to receive the NOx sensor output signal and to provide a NOx model signal that represents an exhaust gas NOx concentration estimate based upon an actual NOx concentration and an actual NH₃ concentration of the exhaust gas. The ECU is arranged to be operable upon the NOx concentration estimate to control the exhaust gas after-treatment system and the internal combustion engine to effect an overall reduction in actual NOx concentration with the exhaust gases.

In accordance with an additional embodiment, the NOx sensor model may be operatively coupled to receive the NOx sensor output signal and to provide a NOx model signal that represents an exhaust gas NOx concentration estimate based upon a linear dependence between the actual NOx concentration and the actual NH₃ concentration of the exhaust gas.

In accordance with an additional embodiment, the NOx sensor model may include a linear dependence operator that linearly relates the actual NOx concentration and the actual NH₃ concentration of the exhaust gas is operatively coupled to receive the NOx sensor output signal and to provide a NOx model signal that represents an exhaust gas NOx concentration estimate.

In accordance with an additional embodiment, the NOx sensor model may include a linear dependence operator that linearly relates the actual NOx concentration and the actual NH₃ concentration of the exhaust gas based upon exhaust gas mass flow data is operatively coupled to receive the NOx sensor output signal and to provide a NOx model signal that represents an exhaust gas NOx concentration estimate.

In accordance with an additional embodiment, the NOx sensor model may include a NOxcalibration vector value and a NH₃calibration vector value. A linear dependence operator that linearly relates the actual NOx concentration and the actual NH₃ concentration of the exhaust gas based upon the NOxcalibration vector value and the NH₃calibration vector value is operatively coupled to receive the NOx sensor output signal and to provide a NOx model signal that represents an exhaust gas NOx concentration estimate based upon a linear dependence between the actual NOx concentration and the actual NH₃ concentration of the exhaust gas.

In accordance with an additional embodiment, the NOx sensor model may be part of a closed loop control structure and operatively coupled to receive the NOx sensor output signal and to provide a NOx model signal that represents an exhaust gas NOx concentration estimate based upon a linear dependence between the actual NOx concentration and the actual NH₃ concentration of the exhaust gas.

In accordance with an additional embodiment, the NOx sensor model may be operatively coupled to receive the NOx sensor output signal and to provide a NOx model signal that represents an exhaust gas NOx concentration estimate based upon a linear dependence between the actual NOx concentration and the actual NH₃ concentration of the exhaust gas. In this embodiment a SCRF model may be operatively coupled to the NOx sensor model to receive the NOx model signal.

In accordance with an additional embodiment, the NOx sensor model may be operatively coupled to receive the NOx sensor output signal and to provide a NOx model signal that represents an exhaust gas NOx concentration estimate based upon a linear dependence between the actual NOx concentration and the actual NH₃ concentration of the exhaust gas in this embodiment a SCRF model may be operatively coupled to the NOx sensor model to receive the NOx model signal. The NOx sensor model and the SCRF model are elements of a closed loop SCRF control structure.

In accordance with an additional embodiment, the NOx sensor model and the ECU may be operatively coupled to receive an operating parameter of the internal combustion engine. The NOx sensor model and the ECU are further arranged to be operable upon the operating parameter to control the exhaust gas after-treatment system and the internal combustion engine to effect an overall reduction in actual NOx concentration with the exhaust gases.

In accordance with another embodiment, a vehicle includes an exhaust gas after-treatment system coupled to an internal combustion engine that includes a selective catalyst reduction on filter (SCRF) exhaust gas after-treatment device in communication with exhaust gases from the internal combustion engine and has a treated exhaust gas output. An oxides of nitrogen (NOx) sensor is in communication with the treated exhaust gases and has a NOx sensor output signal that is NOx and ammonia (NH₃) cross-sensitive. A NOx sensor model is operatively coupled to receive the NOx sensor output signal and to provide a NOx model signal that represents an exhaust gas NOx concentration estimate based upon an actual NOx concentration and an actual NH₃ concentration of the exhaust gas. The ECU is arranged to be operable upon the NOx concentration estimate to control the exhaust gas after-treatment system and the internal combustion engine to effect an overall reduction in actual NOx concentration with the exhaust gases.

In accordance with another embodiment, a controller for a vehicle internal combustion engine exhaust gas after-treatment system is provided. The exhaust gas treatment system includes a selective catalyst reduction on filter (SCRF) exhaust gas after-treatment device in communication with exhaust gases from the internal combustion engine and has a treated exhaust gas output. An oxides of nitrogen (NOx) sensor is coupled to the treated exhaust gas output. The NOx sensor has a NOx sensor output signal that is NOx and ammonia (NH₃) cross-sensitive, and an electronic control unit (ECU) is operatively coupled to the internal combustion engine and the exhaust gas after-treatment system. The controller includes a NOx sensor model coupled to receive the NOx sensor output signal and an exhaust gas mass flow data and to provide a NOx model signal to the electronic control unit. The NOx model signal represents an exhaust gas NOx concentration estimate based upon an actual NOx concentration and an actual NH₃ concentration of the exhaust gas. The ECU is arranged to be operable upon the NOx concentration estimate to control the exhaust gas after-treatment system and the internal combustion engine to effect an overall reduction in actual NOx concentration with the exhaust gases.

In accordance with an additional embodiment, the NOx model signal may represent an exhaust gas NOx concentration estimate based upon a linear dependence between the actual NOx concentration and the actual NH₃ concentration of the exhaust gas.

In accordance with an additional embodiment, the controller may include a NOx sensor model that includes a linear dependence operator that linearly relates the actual NOx concentration and the actual NH₃ concentration of the exhaust gas and is coupled to receive the NOx sensor output signal and an exhaust gas mass flow data and to provide a NOx model signal to an electronic control unit that is operatively associated with the exhaust gas after-treatment system and the internal combustion engine.

In accordance with an additional embodiment, the controller may include a NOx sensor model that includes a linear dependence operator that linearly relates the actual NOx concentration and the actual NH₃ concentration of the exhaust gas based upon the exhaust gas mass flow data and is coupled to receive the NOx sensor output signal and an exhaust gas mass flow data and to provide a NOx model signal to an electronic control unit that is operatively associated with the exhaust gas after-treatment system and the internal combustion engine.

In accordance with an additional embodiment, the controller may include a NOx sensor model that includes a NOxcalibration vector value and a NH₃calibration vector value and a linear dependence operator that linearly relates the actual NOx concentration and the actual NH₃ concentration of the exhaust gas based upon the NOxcalibration vector value and the NH₃calibration vector value. The NOx sensor model is coupled to receive the NOx sensor output signal and an exhaust gas mass flow data and to provide a NOx model signal to an electronic control unit that is operatively associated with the exhaust gas after-treatment system and the internal combustion engine.

In accordance with an additional embodiment, the controller may include a NOx sensor model coupled to receive the NOx sensor output signal and an exhaust gas mass flow data and to provide a NOx model signal to an electronic control unit that is operatively associated with the exhaust gas after-treatment system and the internal combustion engine. In this embodiment, the ECU is arranged to be operable upon the NOx concentration estimate to control the exhaust gas after-treatment system and the internal combustion engine to effect an overall reduction in actual NOx concentration with the exhaust gases. The NOx sensor model is an element of a closed loop control structure.

In accordance with an additional embodiment, the controller includes a NOx sensor model coupled to receive the NOx sensor output signal and an exhaust gas mass flow data and to provide a NOx model signal to an electronic control unit that is operatively associated with the exhaust gas after-treatment system and the internal combustion engine. In this embodiment, SCRF model is further provided and is operatively coupled to the NOx sensor model to receive the NOx model signal.

In accordance with another embodiment, a method of controlling a vehicle internal combustion engine exhaust gas after-treatment system is provided. The exhaust gas treatment system includes a selective catalyst reduction on filter (SCRF) exhaust gas after-treatment device in communication with exhaust gases from the internal combustion engine and has a treated exhaust gas output. An oxides of nitrogen (NOx) sensor is coupled to the treated exhaust gas output. The NOx sensor has a NOx sensor output signal that is NOx and ammonia (NH₃) cross-sensitive. An electronic control unit (ECU) is operatively coupled to the internal combustion engine and the exhaust gas after-treatment system. A NOx sensor model is provided and is operatively coupled to the NOx sensor. The NOx sensor model includes a linear dependency operator. The actual NOx concentration and the actual NH₃ concentration of the exhaust gas are linearly related using the linear dependency operator and an exhaust gas mass flow data to provide a NOx concentration estimate. The SCRF device is controlled in view of the NOx concentration estimate to affect a reduction in an actual NOx concentration of the exhaust gases.

In accordance with an additional embodiment, the SCRF device is controlled in view of the NOx concentration estimate to affect a reduction in an actual NOx concentration of the exhaust gases by providing the NOx concentration estimate to an electronic control unit (ECU) and providing a DEF injection control signal from the ECU to the SCRF device.

### BRIEF DESCRIPTION OF THE DRAWINGS

The present disclosure will hereinafter be described in conjunction with the following drawing figures, wherein like numerals denote like elements.

FIG. 1 is a schematic representation of a vehicle incorporating an after-treatment system applied to an internal combustion engine that is operable in accordance with the herein described embodiments;

FIG. 2 is a block diagram illustration of an after-treatment system in accordance with the herein described embodiments;

FIG. 3 is a block diagram illustration of a NOx sensor model in accordance with a herein described embodiment operable within an after-treatment system; and

FIG. 4 is a block diagram illustration of an after-treatment system in accordance with an alternative herein described embodiment.

### DETAILED DESCRIPTION OF THE DRAWINGS

The following detailed description is merely exemplary in nature and is not intended to limit the invention or the application and uses of the invention. Furthermore, there is no intention to be bound by any theory presented in the preceding background of the invention or the following detailed description. Exemplary embodiments will now be described with reference to the drawings, wherein conventional or commonly known elements may be omitted for clarity.

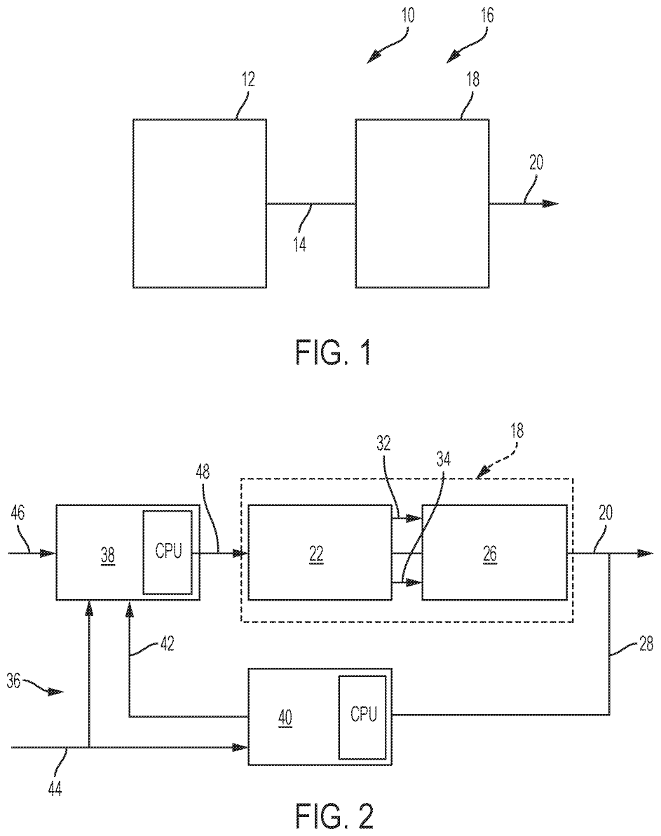

Some embodiments may include an automotive system 10 that as shown in FIG. 1 includes an internal combustion engine (ICE) 12 of conventional construction including an engine block defining at least one cylinder having a piston coupled to rotate a crankshaft. A cylinder head cooperates with the piston to define a combustion chamber. A fuel and air mixture is disposed in the combustion chamber and ignited, resulting in hot expanding exhaust gases causing reciprocal movement of the piston. The fuel is provided by at least one fuel injector and the air through at least one intake port from an intake manifold. The fuel is provided at high pressure to the fuel injector from a fuel rail in fluid communication with a high-pressure fuel pump that increase the pressure of the fuel received a fuel source. Each of the cylinders has at least two valves, actuated by a camshaft rotating in time with the crankshaft. The valves selectively allow air into the combustion chamber and alternately allow exhaust gases to exit through an exhaust port.

The air may be distributed to the air intake port(s) through the intake manifold. An air intake duct may provide air from the ambient environment to the intake manifold. In other embodiments, a throttle body may be provided to regulate the flow of air into the manifold. In still other embodiments, a forced air system such as a turbocharger, having a compressor rotationally coupled to a turbine, may be provided. Rotation of the compressor increases the pressure and temperature of the air in the duct and manifold, and an intercooler disposed in the duct may reduce the temperature of the air.

Exhaust gases 14 produced by the ICE 12 are communicated to an exhaust system 16, which in accordance with the herein described embodiments includes an exhaust gas after-treatment system 18 including one or more exhaust after-treatment devices (not depicted in FIG. 1). The exhaust gases 14 are released from the after-treatment system 18 as treated exhaust gases 20. The after-treatment devices may be any device configured to change the composition of the exhaust gases 14. Some examples of after-treatment devices include, but are not limited to, catalytic converters (two and three way), such as a diesel oxidation catalyst (DOC), lean NOx traps, hydrocarbon adsorbers and selective catalytic reduction (SCR) systems. The after-treatment system 18 may further include a diesel particular filter (DPF), which may be combined with the SCR to provide an SCRF system. Other embodiments may include an exhaust gas recirculation (EGR) system coupled between the exhaust manifold and the intake manifold. The herein described embodiments are amenable to virtually any combination of after-treatment devices, and it is typical that the after-treatment system 18 will include more than one such device.

With continued reference to FIG. 1 and reference now also to FIG. 2, in addition to other after-treatment devices that may be provided within the after-treatment system 18 (not depicted in FIG. 2), the after-treatment system 18 includes a SCRF 22. A NOx sensor 26 is provided to monitor composition of the treated exhaust gas 20. The NOx sensor 26 provides data in the form of an electric signal output (NOxmeas) 28 indicative of a concentration of NOx 32 and ammonia (NH₃) 34 in the treated exhaust gas from the SCRF 22 and emitted as treated exhaust gas 20.

A control structure 36 is operatively associated with the after-treatment system 16 and, in accordance with the herein described embodiments, at least includes an electronic control unit (ECU) 38 and a NOx sensor model (NSM) 40. The NSM 40, while depicted standalone may form a portion of or be combined with a broader after-treatment system model structure within the control structure 36, and for example, the NSM 40 may be combined with or a component of a SCR/SCRF model or controller. In the embodiment depicted, the ECU 38 and the NSM 40 are operatively coupled to receive data in the form of electronic signals from one or more sensors and/or devices associated with the ICE 12 represented as ICE sensor and modules data hereinafter referred to as U_{ICE} 46. The ECU 38 may receive U_{ICE} 46 signals from various sensors configured to generate the signals in proportion to various physical parameters associated with the ICE 12. The sensors include, but are not limited to, a mass airflow and temperature sensor, a manifold pressure and temperature sensor, a combustion pressure sensor, coolant and oil temperature and level sensors, a fuel rail pressure sensor, a cam position sensor, a crank position sensor, an exhaust pressure sensor and an exhaust temperature sensor, exhaust gas flow sensor, an EGR temperature sensor, and an accelerator pedal position sensor. Furthermore, the ECU 38 may generate output signals to various control devices that are arranged to control the operation of the ICE 12, including, but not limited to, the fuel injectors, the throttle body and other devices forming part of the after-treatment system 18. The ECU 38 may furthermore receive additional control inputs, such as but not limited to, ambient air temperature, ambient pressure, vehicle speed, gear selected, and the like, hereinafter CIs 44.

In accordance with herein described embodiments, the ECU 38 at least provides a DEF injection signal 48 causing the DEF system (not depicted) to inject a measured quantity of Diesel exhaust fluid or DEF into the exhaust gas flow upstream the SCRF 22. As is known, the DEF is hydrolysized to produce NH₃, which is reacted with the exhaust gas flow within the SCRF 22. An exhaust gas output of the SCRF 22 is exhaust gas consisting primarily of N₂ and H₂O, but also having NOx 32 and NH₃ 34 components.

Each of the ECU 38 and the NSM 40 may include a digital central processing unit (CPU) having a microprocessor in communication with a memory system, or data carrier, and an interface bus. The microprocessor is configured to execute instructions stored as a program in the memory system, and send and receive signals to/from the interface bus. The memory system may include various storage types including optical storage, magnetic storage, solid-state storage, and other non volatile memory. The interface bus may be configured to send, receive, and modulate analog and/or digital signals to/from the various sensors and control devices. The program may embody the methods disclosed herein, allowing the ECU 38 and the NSM 40 to carryout out such methods and control the ICE 12 and the after-treatment system 18. Instead of a CPU, the ECU 38 and/or the NSM 40 may have a different type of processor to provide the electronic logic, e.g. an embedded controller, an onboard computer, or any processing module that might be deployed in the automotive system 10.

The program stored in the memory system is transmitted from outside via a cable or in a wireless fashion. Outside the automotive system 10 it is normally visible as a computer program product, which is also called computer readable medium or machine readable medium in the art, and which should be understood to be a computer program code residing on a carrier, said carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulation technique such as QPSK for digital data, such that binary data representing said computer program code is impressed on the transitory electromagnetic signal. Such signals are e.g. made use of when transmitting computer program code in a wireless fashion via a WiFi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an ASIC, a CD or the like.

The NOx sensor 26 is cross-sensitive to both NOx and NH₃, and the data signal NOxmeas 28 is a function of the NOx 32 and NH₃ 34 components, namely, the actual concentration of NOx or C_{NOx} and the actual concentration of NH₃ or C_{NH3} of the treated exhaust gas 20 output from the SCRF 22. As such, the NOxmeas 28 signal itself is not sufficient for effective DEF injection determination. In accordance with the herein described embodiments, the NSM 40 is operable to provide a NOx model concentration value (NOx_{model}) 42 accurately reflecting exhaust gas NOx concentration within the exhaust gas for a given exhaust mass flow rate. In one implementation, the NSM 40 provides the NOx_{model} 42 signal as an estimation in view of the linear dependence operator (K) of NOₓ/NH₃ cross-sensitivity for given exhaust gas flow (\dot{m}), which may be represented as:

K(\dot{m})=A\dot{m}+B,

where A and B are calibration values. Furthermore, given the linear relationship

NOxmeas=NOxreal+K(\dot{m})·NH3

the linear dependence operator K may be given as:

$$K ( \dot{m} ) = \frac{NOxcalibration - NOxrealer}{{NH}_{3} calibration} .$$

Hence, it is possible to define the value NOx_{model} 42 as:

NOxmodel=NOxcalibration+K(\dot{m})·NH₃calibration

where NOxcalibration and NH₃calibration are calibration vector values determined by bench calibration. Bench calibration to determine the NOxcalibration and NH₃calibration vector values may be accomplished by measuring NOx and NH₃ concentration levels in an exhaust gas stream under specific control of DEF injection using suitable discrete gas analyzers, Fourier transform infrared spectroscopy (FTIR) or any other suitable methodology.

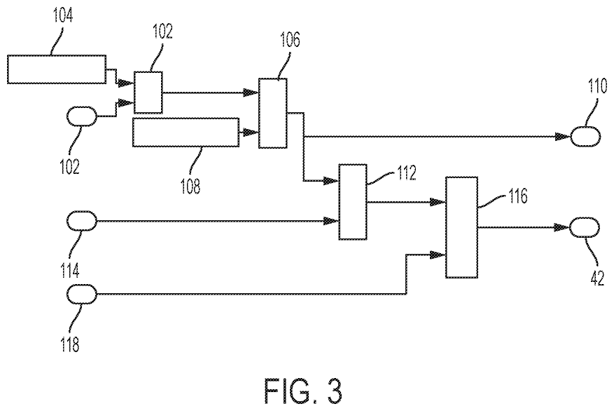

FIG. 3 graphically depicts the NSM 40. At 100 the product of an exhaust gas mass flow (\dot{m}) value 102, which may be directly measured or inferred from intake mass flow, and the calibration value 104 (A) is made. At 106, the resulting product is added to the calibration value 108 (B) to provide the linear dependence operator (K) 110. At 112 the product of the linear dependence operator K and the NH₃calibration vector 114 is made. At 116, the resulting product is added to the NOxcalibration vector 118 to provide the NOxmodel value 42.

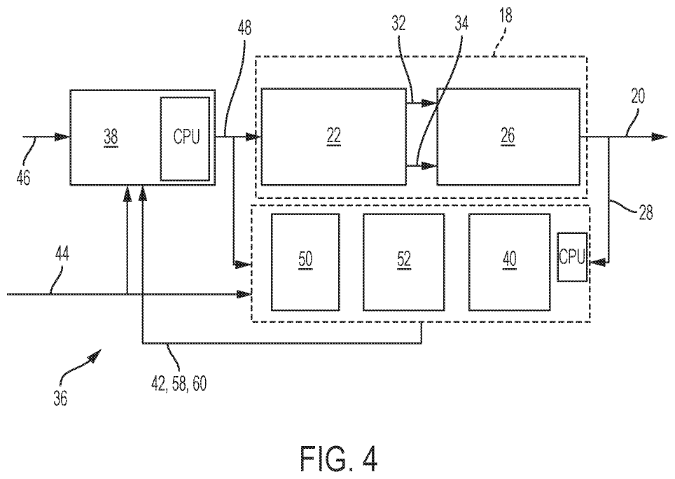

The NSM 40 may implemented as a standalone control element capable of providing an estimated NOx value, NOxmodel, 42 to the ECU 38 for after-treatment 16 system control. As depicted in FIG. 4, the NSM 40 may be combined with a selective catalyst reduction (SCR) model 50 and a filter 52 in a closed loop model. The closed loop model also is operatively coupled to receive the signal 28 from the NOx sensor 26, the DEF injection signal 48 and the U_{ICE} 46 data. The closed loop model 54 is operatively configured to provide an NOx concentration accuracy value representing SCRF performance based upon the NOxmodel value. The ECU 38 may be operatively configured as a closed loop controller employing any suitable control strategy to effect determination and injection of DEF via the DEF injection signal 48 to optimize the estimated concentration of NOx in the emitted exhaust gas given U_{ICE} 46, CIs 44, the estimated ammonia coverage 58, the estimated ammonia concentration 60 and the NOxmodel value.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

What is claimed is:

1. An exhaust gas after-treatment system for an internal combustion engine comprising:
a selective catalyst reduction on filter (SCRF) exhaust gas after-treatment device in communication with a source of exhaust gases and having a treated exhaust gas output;
an oxides of nitrogen (NOx) sensor coupled to the treated exhaust gas output, the NOx sensor having a NOx sensor output signal that is NOx and ammonia (NH₃) cross-sensitive;
a NOx sensor model coupled to receive the NOx sensor output signal and an exhaust gas mass flow data signal and to provide a NOx model signal to an electronic control unit that is operatively associated with the exhaust gas after-treatment system and the internal combustion engine, wherein
the NOx model signal represents an exhaust gas NOx concentration estimate based upon an actual NOx concentration and an actual NH₃ concentration of the exhaust gas and the ECU is arranged to be operable upon the NOx concentration estimate to control the exhaust gas after-treatment system and the internal combustion engine to effect an overall reduction in actual NOx concentration with the exhaust gases.

2. The exhaust gas after-treatment system of claim 1, wherein the NOx concentration estimate is based upon a linear dependence between the actual NOx concentration and the actual NH₃ concentration of the exhaust gas.

3. The exhaust gas after-treatment system of claim 1, wherein the NOx sensor model comprises a linear dependence operator that linearly relates the actual NOx concentration and the actual NH₃ concentration of the exhaust gas.

4. The exhaust gas after-treatment system of claim 1, wherein the NOx sensor model comprises a linear dependence operator that linearly relates the actual NOx concentration and the actual NH₃ concentration of the exhaust gas based upon the exhaust gas mass flow data.

5. The exhaust gas after-treatment system of claim 1, wherein the NOx sensor model comprises a NOxcalibration vector value and a NH₃calibration vector value and a linear dependence operator that linearly relates the actual NOx concentration and the actual NH₃ concentration of the exhaust gas based upon the NOxcalibration vector value and the NH3calibration vector value.

6. The exhaust gas after-treatment system of claim 1, wherein the NOx sensor model is an element of a closed loop control structure.

7. The exhaust gas after-treatment system of claim 1, further comprising a SCRF model operatively coupled to the NOx sensor model to receive the NOx model signal.

8. The exhaust gas after-treatment system of claim 7, wherein the SCRF model is configured to provide an exhaust gas NOx concentration accuracy value.

9. The exhaust gas after-treatment system of claim 7, wherein the NOx sensor model and the SCRF model are elements of a closed loop SCRF control structure.

10. The exhaust gas after-treatment system of claim 1, wherein NOx sensor model and the ECU are operatively coupled to receive an operating parameter of the internal combustion engine, wherein the NOx sensor model and the ECU are further arranged to be operable upon the operating parameter to control the exhaust gas after-treatment system and the internal combustion engine to effect an overall reduction in actual NOx concentration with the exhaust gases.

11. A vehicle comprising an exhaust gas after-treatment system in accordance with claim 1.

12. A controller for a vehicle internal combustion engine exhaust gas after-treatment system, the exhaust gas treatment system including a selective catalyst reduction on filter (SCRF) exhaust gas after-treatment device in communication with exhaust gases from the internal combustion engine and having a treated exhaust gas output, an oxides of nitrogen (NOx) sensor coupled to the treated exhaust gas output, the NOx sensor having a NOx sensor output signal that is NOx and ammonia (NH₃) cross-sensitive, and an electronic control unit (ECU) operatively coupled to the internal combustion engine and the exhaust gas after-treatment system, the controller comprising:
a NOx sensor model coupled to receive the NOx sensor output signal and an exhaust gas mass flow data signal and to provide a NOx model signal to the ECU that is operatively associated with the exhaust gas after-treatment system and the internal combustion engine, wherein
the NOx model signal represents an exhaust gas NOx concentration estimate based upon an actual NOx concentration and an actual NH₃ concentration of the exhaust gas and the ECU is arranged to be operable upon the NOx concentration estimate to control the exhaust gas after-treatment system and the internal combustion engine to effect an overall reduction in actual NOx concentration with the exhaust gases.

13. The controller of claim 12, wherein the NOx concentration estimate is based upon a linear dependence between the actual NOx concentration and the actual NH₃ concentration of the exhaust gas.

14. The controller of claim 12, wherein the NOx sensor model comprises a linear dependence operator that linearly relates the actual NOx concentration and the actual NH₃ concentration of the exhaust gas.

15. The controller of claim 12, wherein the NOx sensor model comprises a linear dependence operator that linearly relates the actual NOx concentration and the actual NH₃ concentration of the exhaust gas based upon the exhaust gas mass flow data.

16. The controller of claim 12, wherein the NOx sensor model comprises a NOxcalibration vector value and a NH₃calibration vector value and a linear dependence operator that linearly relates the actual NOx concentration and the actual NH₃ concentration of the exhaust gas based upon the NOxcalibration vector value and the NH3calibration vector value.

17. The controller of claim 12, wherein the NOx sensor model is an element of a closed loop control structure.

18. The controller of claim 12, further comprising a SCRF model operatively coupled to the NOx sensor model to receive the NOx model signal.

19. A method of controlling a vehicle internal combustion engine exhaust gas after-treatment system, the exhaust gas treatment system including a selective catalyst reduction on filter (SCRF) exhaust gas after-treatment device in communication with exhaust gases from the internal combustion engine and having a treated exhaust gas output, an oxides of nitrogen (NOx) sensor coupled to the treated exhaust gas output, the NOx sensor having a NOx sensor output signal that is NOx and ammonia (NH₃) cross-sensitive, and an electronic control unit (ECU) operatively coupled to the internal combustion engine and the exhaust gas after-treatment system, the method comprising:
providing a NOx sensor model operatively coupled to the NOx sensor and including a linear dependency operator;
linearly relating the actual NOx concentration and the actual NH₃ concentration of the exhaust gas using the linear dependency operator and an exhaust gas mass flow data to provide a NOx concentration estimate; and
controlling the SCRF device in view of the NOx concentration estimate to affect a reduction in an actual NOx concentration of the exhaust gases.

20. The method of claim 19, wherein controlling the SCRF device comprises providing the NOx concentration estimate to an electronic control unit (ECU) and providing a DEF injection control signal from the ECU to the SCRF device.
